(19) United States
(12) Patent Application Publication
(10) Pub. No.: US 2004/0068729 A1
(43) Pub. Date: Apr. 8, 2004

(54) Non-hierarchical collaborative computing platform

(76) Inventors: Oren Simon, T. P. Emek Hefer (IL); Ayala Rahav, Tel Aviv (IL); Tomer Radian, Lapid (IL)

Correspondence Address: Edward Langer, 60th Floor, 350 Fifth Avenue, New York, NY, 10118, US

(21) Appl. No.: 10/467,795

(22) PCT Filed: Feb. 14, 2002
(86) PCT No.: PCT/IL02/00116

(51) Int. Cl. G06F 15/16

(52) U.S. Cl. 718/102; 709/201

(57) ABSTRACT

A system for non-hierarchical collaborative computing, comprising at least two basic nodes, wherein each of the basic nodes has at least one agency, each of the agencies having incorporated therein a collaborative protocol, wherein the collaborative protocol enables a non-hierarchical collaborative computer processing to occur within said system.

### FIELD OF THE INVENTION

The present invention relates to the field of large scale computing platforms. More specifically, the present invention relates to a method and system for replacing the control-flow processing method in large scale computing environments with a data flow processing method.

### BACKGROUND OF THE INVENTION

Today's high-end computers use a variety of approaches in order to break through the processing speed barrier of a few Teraflops/Second using hundreds or thousands of processing devices, usually built in huge, especially designed machines. Such approaches include the Symmetric Multi Processing approach (“SMP”), which is a computer architecture in which at least 2 processors are running and sharing memory simultaneously, the Constellations approach, the Clusters approach, the massively parallel processing approach (“MPP”), the “SMID” approach, and others.

However, these expensive machines are increasingly inefficient, as they require the allocation of considerable resources solely for the purpose of enabling the parallel operation of the many processing nodes comprising said machines. Consequentially, as machines grow and increase in processing power, the gap between the aggregated nominal capacities of the individual processors comprising said machines, and the total capacity of the machine itself is increasing.

Recently, a different approach towards increasing processing power was taken. According to this approach, distributed grid computers comprising a collection of machines, each of which having a processing unit, a memory unit and an I/O unit, harness their available resources throughout the domain of a network, and in some cases, even the Internet. While this grid approach enables the harnessing of an even greater total number of processors than was achieved by the abovementioned approaches of building one huge machine with many processors, even this grid approach suffers from the abovementioned increasing inefficiency.

It is believed that one cause for this increasing inefficiency is the control-flow oriented paradigm used as the basic architectural principle for computation systems, according to which resources are allocated at some hierarchically higher level than the processors themselves to control the flow of activities.

As a result, when increasing the computing power of a machine, more activities are being performed. Inevitably, the increase in the number of activities per time unit also increases the amount of resources required to be allocated for the purpose of flow control. Thus, despite the fact that the aggregated capacity of the processing devices comprising big systems is growing exponentially, the growth of the capacity of the High Performance Computers is substantially linear.

Examples for the bottlenecking phenomena associated with contro-flow systems can be found in the field of Very Large Data Bases (“VLDB”). While the need for large-scale parallel database systems is rapidly increasing, the ability to scale up a database is limited by the need to synchronize and maintain the integrity of the data.

In VLDB designs, control elements responsible for data integrity (i.e., lock mechanisms that prevent multiple writing of data by giving exclusive write permission to a specific process while other processes attempting to modify the same data are blocked), although an effective approach as long as the rate of concurrent write attempts is relatively low, become bottlenecks once concurrent write requirements are high.

Even massively distributed environments such as Sun Microsystems' JINI, suffer from the same limitation. JINI uses the concept of look-up servers to enable entities to explore available services that they can use. For relatively small environments this approach is adequate, but once the number of entries in a look-up becomes big, the time required to look something up becomes too long for practical use. Furthermore, in fast changing environments, the rate of collisions between parallel attempts to register and update different services on a look-up server renders the system inoperable.

### OBJECTS AND SUMMARY OF THE INVENTION

Thus, it is an object of the present invention to provide a method and system to replace known control-flow processing methods used in large scale computing environments with a data-flow processing method.

It is still another object of the present invention to substantially decrease the total amount of system resources allocated for the purpose of managing the parallel operation of a plurality of processing nodes.

It is yet another object of the present invention to provide a method and system that will decrease the gap between aggregated nominal capacities of individual nodes comprising a system and the total capacity of the system itself.

These objects, and others not specified hereinabove, are achieved by the present invention, an exemplary embodiment of which comprises a nonhierarchical network of nodes, each node comprising a processing unit, a memory unit and a communication unit. The nodes include a collaboration protocol, which permits any one node to avail itself of the private resources of other nodes in the cluster or even other nodes from outside the cluster by issuing task offers to the cluster nodes.

The present invention is a system for non-hierarchical collaborative computing, comprising at least two basic nodes, wherein each of these basic nodes has at least one agency, and each of the agencies have incorporated therein a collaborative protocol, wherein the collaborative protocol enables a non-hierarchical collaborative computer processing to occur within the system of the present invention.

Each of the abovementioned basic nodes comprises a processor unit, a random access memory unit and a communication device (e.g., network card to a LAN, WAN, WWW, etc.). In addition, nodes may have, in addition, input and output devices, hard disks as well as any other hardware components which add to their functionality.

The system of the present invention works in accordance with the principle that any hardware functionality and/or device is represented by a functioning corresponding software object. For instance, there are objects representing a keyboard, a monitor, a CPU, hard disks, portable disks, random access memory units, schemes, algorithms etc. These objects are used to form agencies representing the actual components of the system.

Each of the abovementioned agencies comprises a dynamic storage object, a processing object, and a communication object. In addition to these components, agencies may also include a peripheral input device object, a peripheral output device object, a persistent storage object as well as other objects representing other resources available to the agency holding the objects.

The system of the present invention uses a method for processing of tasks, to be used in a distributed computation cluster. Said method may be referred to as an auction in which one of the nodes of the system offers a task for auction (i.e., sends a request to the other nodes of the system, asking who can perform a certain task for it, and stating what are the parameters required from the nodes that wish to bid for the offer) and therefore is referred to as auctioner. The other nodes in the system evaluate the offer, and if the offer is such that they can accept (i.e., if they meet the requirements of the auctioner for performing the offered task), they bid for the offer (i.e., send responses to the auctioner informing it that they can perform the task and let it know what are their performance capabilities). Once all bids are accepted by the auctioner, the auctioner evaluates the bids, and selects the best one (i.e., the bid which offered best performance of the task). In the following steps the auctioner select one of the bidding nodes to be the winner (i.e., to be the node which performs the task).

In accordance with the abovementioned analogy, it may be said the abovementioned distributed computation cluster of the present invention comprises an auctioning node and a plurality of receiving nodes, which interact in accordance with an auctioning method which comprises the steps of: [a] generation and transmission of an offer from the auctioning node to the receiving nodes; [b] evaluation of the offer by each of the receiving nodes to arrive at a determination of the receiving nodes' offer-fulfillment capability; [c] generation and transmission of bids by bidding nodes to the auctioning node, the bidding nodes comprising those of the receiving nodes that make a positive determination of offer-fulfillment capability; [d] evaluation of the bids by the auctioning node to select a preferred bidding node; [e] acceptance of a preferred bid by the auctioning node and sending the auctioned task to the bidding node which originated the preferred bid; [f] processing of the task by the bidding node; and [g] transmission of the results of the processing back to the auctioning node.

The system of the present invention works in accordance with a non-hierarchical collaborative protocol, which means that there is no constant hierarchy between the various nodes comprising the system. It should be noted that by saying that there is no constant hierarchy we mean that in certain period of times, temporary hierarchies do exist in the system, for instance, when one of the nodes issues a task for performance by another node. Said temporary hierarchies are unforeseeable, since each of the nodes can either be at the top of the hierarchy or at its bottom, in any given period of time. Therefore, the system of the present invention will be referred to as a non-hierarchical system.

In light of the above, the system of the present invention is also described as a community of computing units, wherein each of the computing units comprises a non-hierarchical collaborative protocol, at least one processing object, at least one dynamic storage object and a communication object, said community of computing units being communicatively interconnected with one another. The abovementioned non-hierarchical collaborative protocol comprises a data-flow paradigm.

### BRIEF DESCRIPTION OF THE DRAWINGS

The detailed description of the exemplary embodiments of the present invention which follows, may be more fully understood by reference to the accompanying drawings, in which:

FIG. 1 is a flow chart illustrating an exemplary embodiment of a task picking function in accordance with an aspect of the present invention;

FIG. 2 is a schematic flow chart illustrating an exemplary embodiment of the relationships between listening tasks in accordance with an aspect of the present invention;

FIG. 3 is a flow chart illustrating an exemplary embodiment of a listen task shown in FIG. 2 hereinabove, in accordance with an aspect of the present invention;

FIG. 4 is a flow chart illustrating an exemplary embodiment of a listen task shown in FIG. 2 hereinabove, in accordance with an aspect of the present invention;

FIG. 5 is a flow chart illustrating an exemplary embodiment of a listen task shown in FIG. 2 hereinabove, in accordance with an aspect of the present invention;

FIG. 6 is a flow chart illustrating an exemplary embodiment of a listen task shown in FIG. 2 hereinabove, in accordance with an aspect of the present invention; and

FIG. 7 is a schematic diagram illustrating an exemplary embodiment of a collaborative computational platform constructed in accordance with the present invention.

### DETAILED DESCRIPTION OF THE PRESENT INVENTION

The system and method of the present invention presents a novel approach for multi-processor high-performance-computing (“HPC”), based on a data-flow paradigm instead of the conventional control-flow. Rather than controlling the flow (and therefore limiting scalability) the system of the present invention is based on a collaboration protocol for enabling true peer-to-peer collaboration between resources. This is achieved by using a data-flow model according to which all participants in the collaboration, referred to hereinbelow as objects, are actually peers asking for volunteers to perform a service, accepting respondent offers to perform the service from remote peers, thereby relinquishing control of the service and permitting the remote peer to perform the service independently.

The system and method of the present invention provide an architecture, a framework and an application for creating large scale computation/storage platforms deployed over a distributed networked environment in which computation, storage and communication devices can collaborate to achieve a common goal, for example, running a complex parallel distributed computation application.

Physically, the system of the present invention is a network of computation devices that use a non-hierarchical collaboration protocol to self-balance, assign and retrieve tasks and information in a collaborative mode. The system of the present invention is based on several key concepts that are outlined henceforth.

Objectification

In accordance with the system of the present invention, all the parts comprising a network or multiprocessor computer system which play any operational role whatsoever are represented by means of objects. For example, objects are used to represent human operators, physical devices, providing details of the physical devices' attributes and values, etc. Additionally, segments of code or other types of data are also referred to as objects.

For example, if a device is required to perform a task which requires manipulating a specific set of data using a given algorithm, the object representing the physical device performing the task assumes the object containing the task. This task containing object invokes a process object (containing the code of the algorithm which manipulates the data) with reference to the data objects to be manipulated.

Self Control

The system of the present invention has no top-level managing functions or control points, i.e. it runs by itself. Its inherent architecture is of a self-controlled, non-hierarchical environment, operating in a data-flow model, rather than the typical control-flow model operating computation platforms in accordance with the prior art.

The collaboration protocol of the present invention enabling the collaboration of the components comprising the system of the present invention is based on negotiation procedures and on the consequential creation of ad-hoc teams and activity chains by means of mutual agreements between the collaborating components to perform specific tasks presently pending.

One of the outcomes of the self-control approach is that the system of the present invention is scaleable to any size, as there is no controlling component who's resource consumption rate is increased whenever the size is scaled. Another consequence of the self-control approach is that the system of the present invention has no look-up services or database lock and synchronization mechanisms, nor many of the bottle-neck creating features of the computation platforms operating in accordance with the prior art. The system of the present invention dynamically configures itself to handle variable task loads by creating ad hoc virtual teams of nodes. Thus, specific tasks are performed by means of parallel multi-node tasking. The collaborative system uses chaining of activities performed by individual nodes to create a virtual sequence in which the isolated components participate in an ad hoc value adding chain.

Fault Tolerance

The system of the present invention is incapable of losing a task or a piece of information. This statement is true for operations within the system of the present invention. At gateway points into the system, it is assumed that an entity requesting performance from the system of the present invention is capable of resubmitting a request if it is timed out in order to achieve a completely fault-tolerant environment. Even under extreme situations (for example a computer freeze in mid process) the worst-case scenario is of having to repeat some of the already performed sub-tasks that will automatically regenerate on a different member portion or node of the system.

One of the important results of the fault tolerance is that devices can be hot-swapped, added, or disjoined, without any need to administer the system.

Balance and Optimization

The system of the present invention self balances its resources and constantly optimizes (as part of its inherent features) to the load of tasks it is performing at any given period of time. This is achieved, amongst other ways, by means of changing the role of the different nodes comprising the system of the present invention. There is no need to reconfigure and set-up a node when its role is being changed.

As an example, a specific node in the system of the present invention assumes the role of gateway for requests arriving from environments external to the system. As a result, data and process objects required by the gateway entity will start migrating within the system of the present invention to physical components, which are topologically closer to the gateway. Migration will occur in accordance with the nature of the specific requirements coming through the gateway.

If the gateway can't handle the load or its neighborhood can't, it will seek an additional gateway machine to share its load, which will form a specialized neighborhood around itself.

An object can be invoked by other objects and can invoke other objects as part of its participation in the system of the present invention (e.g., an executable object that needs to manipulate data in another object can invoke the relevant data object, manipulate it, and then invoke another object responsible for restoring the updated data object).

Some of the objects are inherent to the system of the present invention, (i.e., used by the platform to perform its process), while other objects are application dependent and are related directly to the specific function the present state of the system of the present invention is assigned to perform.

Basically there are three archetypes of objects:

Passive objects—contain inert data about something.

Active objects—contain procedures for executing specific types of activities.

Task objects—contain assignments for performing an activity defined as required by a node within the system of the present invention, and pointers to the relevant Passive and Active objects.

Passive Objects

There are three classes of information types that are contained in passive objects:

Inventory objects—contain information about objects maintained in a specific zone or that are components in the construct of computation devices participating in the system of the present invention.

External descriptive objects—contain information about entities outside the system of the present invention enabling it to communicate with them. Such information might include APIs and protocols.

General data objects—contain data which is relevant to a process performed by the system of the present invention.

Inventory Objects

The system of the present invention uses a variety of inventory objects enabling nodes to evaluate content available in specified areas.

One of these inventory objects is the physical construct inventory object, which is an inventory object, especially created for each of the nodes comprising the system.

Physical Construct Inventory Objects

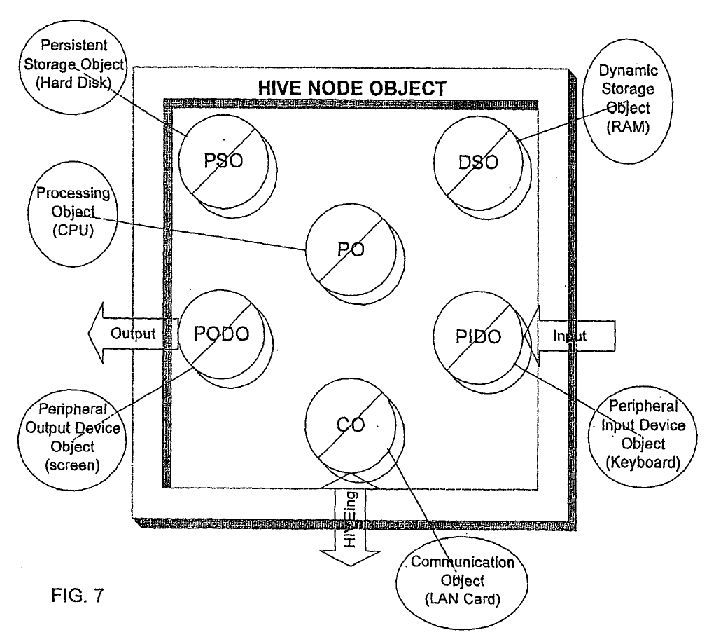

With reference to FIG. 7, the system of the present invention can incorporate as a node, any computation, storage and communication device as long as that device runs an appropriate operating system that supports said system's requirements of thread activation, processing, memory management and communication. A node does not necessarily have to be dedicated to the system, but merely able to satisfy the basic node definition, as defined hereinbelow, this in addition to whatever other local or network requirements it must meet. Any such device can be described as being composed of a combination of some or all of the following six types of physical components (this list is only exemplary since said devices can also be composed of any other physical component which is useful for the system of the present invention):

PIDO—Peripheral Input Device Object—enables the gathering of information from outside the system and entering it into the system.

PODO—Peripheral Output Device Object—enables sharing results obtained in the system with external entities.

PSO—Persistent Storage Object—enables persistent storage (hard disks, tape drives, etc.) of information within the system.

DSO—Dynamic Storage Object—enabling temporary storage (RAM) of information used by the system to perform its tasks.

PO—Processing Object—enabling processing of executable code.

CO—Communication Object—enabling interaction between the system components.

The node representation of the abovementioned physical devices is a combination of some or all of the abovementioned objects.

Combinations that are not practical or nonsensical are excluded from the possible valid combinations (i.e., there is no point in having any device object which has no CO as it will not be able to interact with other nodes in the system).

The following (non-exhaustive) list details the required components that a node must have for it to assume a specific role. One node can assume more than one role as long as the minimum requirements for each of the assumed roles (within the component's capacity) are satisfied.

Basic Node—A basic node, also referred to as a computing unit, must include a CO, a PO and a minimum size DSO (so that the PO requirements are supported). A basic node is only capable of performing tasks (i.e., it cannot store data since it has no PSO nor can it display data since it has no PODO).

RAM Machine—RAM machine is a basic node with a large DSO, containing on its RAM objects that are frequently required by processes that run on said node, or that run on other nodes, in which case it is used as a distributed cache.

Storage Machine—Storage machine is a basic node with a PSO. Storage machines maintain data on hard drives, tapes etc. The Storage machine requires allocation from its DSO and PO components to manage the store.

Input/Output Device—Input/Output device is a basic node further equipped with peripheral input/output devices (i.e. Input: Keyboard, Microphone, IR sensor etc., output: Display, Speakers etc.).

Gateway—A gateway is a node having at least two CO components. The first handles traffic within the system of the present invention (also referred to hereinafter as “int rnal leg”), and the other handles traffic to and from external entities (e.g., another network) (also referred to hereinafter as “xt rnal leg”).

External Objects

In order to enable the system of the present invention to communicate with the external world, an interface must be defined. The data related to these interfaces is contained in external entity objects.

As an example, a system administrator can select a particular node through which he/she is working (a PIDO/PODO node), and identify it to the system as such. Once the information is entered, a special external object is created. Said external object tells the system of the present invention how and where messages to the administrator are to be sent.

General Information Objects

Any type of information that is required by the system of the present invention for a particular process in which execution it is engaged, is maintained in a general information object.

Active Objects

Processes that the system of the present invention performs (the executables) are contained in active objects. Said processes are actually scripts telling nodes, that have loaded them for execution, how to manipulate other objects (passive, active or tasks) to achieve a desired goal.

Task Objects

Task Objects contain pointers to active and passive objects in order to achieve a specific goal.

An example may be a task defining two input passive objects containing numbers, a third passive object defined as a target for output and a pointer to an active object containing a multiplication process. (i.e., target=product(input1, input2)).

Collaboration Protocol

The system of the present invention is a collaborative platform of a plurality of individual computing devices which interact in a control-free, non-hierarchical environment using the data-flow paradigm.

The system of the present invention enables the collaboration between the individual computing devices, referred to as nodes, by means of a collaboration protocol. Said collaboration protocol is a structured procedure of negotiations between the individual nodes, during which bidding of tasks is made, which results in assignment of the tasks to one or more of the individual nodes for execution. The collaboration protocol actually creates temporary interrelationships between nodes, relationships which characteristics depend upon the nature of the task.

I Am My Own Master

The nodes comprising the system of the present invention make their own decisions. Any reassignment of responsibilities between any two node objects is the result of an agreement (contract), in which the node issuing the request evaluates the offer for services as best suiting its needs and the nodes responding to the request accepts the responsibility of performing the request based on its own evaluation of its capabilities and workload.

Introspection

In order for a node object to determine if it is bidding for the acceptance of an offer posted by an issuing node, it must be aware of its own state and capabilities.

Introspection is used for developing this self-awareness on two distinct layers:

Physical (see “I Know What I Am” header hereinbelow)

Knowledge (see “I Know What I Know” header hereinbelow)

I Know What I Am

Before becoming one of the nodes comprising the system of the present invention, all node objects run an introspect procedure as part of their installation process. This introspect procedure develops the node's physical state self-awareness (i.e., its own capabilities and qualifications).

The result of the introspection performed by the node is registered internally in an inventory object containing the information related to the physical objects arrangement of the node. Said inventory object also contains the parameters which constitute each of said physical objects.

By referring to this object, a node can make decisions regarding its compatibility with the requirements outlined in issued requests, and according to said compatibility bid or pass on a contract proposal.

I Know What I Know

Any node object also maintains awareness of what it knows (i.e., the identity of the objects it has locally stored on its DSO or PSO, and data regarding the nodes' optimal load factors). Said information is maintained in an inventory object.

Availability, Relevance, Optimization

A contract between an issuing node and a responding node is negotiated based on three parameters:

Is the responding node available to assume additional load?

Is the responding node relevant for the execution of the task at hand?

Which of the responding nodes' offerings is the optimum offer?

I Know What I Can

It is the responsibility of the responding node to evaluate its own state and decide if it is capable of performing a task. Such a decision is based on the responding node's availability to assume the load associated with the execution of the requested task and on the degree of relevance it has for the execution of the requested task (how much of the required knowledge do I have—see the “I know what I am” and the “I know what I know”headers).

Active objects defining various evaluation procedures are available in the system.

Each request points to one or more of said evaluation procedure objects, which are loaded by the responding nodes, for the purpose of determining whether to respond to the request or not (i.e., the pointing to said one or more evaluation procedure objects enables the responding node to load the matching evaluation scheme and thereby perform the evaluation).

Availability

A responding node cannot bid for additional workload if it does not have the capacity to perform said additional workload.

The system of the present invention uses a broadcast channel (also referred to herein as multicast) to request resource allocation from the node objects. All node objects which have the capacity (availability) to assume additional responsibilities are listening to said multicast by means of the multicast port of their respective CO component. In cases when all the threads of a node object are otherwise engaged, the node object ceases to listen on the multicast ports of its CO component. Consequentially, only available node objects perform evaluation of new requests for bid.

While actually listening is a prerequisite for availability it is not the only one. Depending on the workload the node is handling, it decides if it is available to a specific type of request. A heavily loaded node may decide not to bid on a task that involves a lot of computation, even though it is listening on the multicast, and despite the fact that it bids on tasks which require lesser computation.

Relevance

Requests for task performing posted by node objects disclose the relevant parameters for the execution of the tasks (relevant processes and data and the required level of relevance) so that available nodes, evaluating the request can decide if they are relevant enough.

For example, if the execution of a task requires specific data objects, and the task's relevance setting is for data to be DSO available, only nodes having said data on their DSO will respond as relevant.

And the Winner Is . . .

Responses for a request include two implicit and two explicit components.

The availability of the responder is implied by the fact that a response was sent—otherwise the node would not have responded.

The location in the queue of responses (or receiving time of the response) indicates the closeness of the responding node to the issuing node in terms of network topological distance.

Additional explicit information is provided by the responding node in its “I know what I can”, which includes the degree of relevance of the responding node (equal or greater than requested) and its estimation of the time it will require to execute the task.

Based on these pieces of information the issuing node decides which of the responding nodes is assigned with the execution of the task.

The issuing node decides on the “winner” node by means of a decision scheme.

Active objects defining the various decision schemes are available in the system.

Each request points to one or more of said decision schemes. Said decision schemes, to which the requests point, are loaded by the issuing node for the purpose of determining who is the winning responding node.

Agencies

All the nodes in the system are running agencies that are responsible for managing operations and for regulating the node's collaborative participation in the collaboration process.

An agency is basically a thread allocation system picking tasks (to be performed by the node) from a queue, a set of queues or a Java Space or any other adequate implementation of a task repository.

Listening

A listening task fetches data from a given port (on the CO of the node) and execute based on what it finds.

By using the listening tasks, the node is freed from a busy-wait state. If, in order to complete a task, additional data and/or processing is required to be gathered/performed from/by other nodes, a request is sent out and a listening task is inserted into task repository, freeing the thread to perform another task.

Eventually, once an available thread picks up the listening task, the results required are fetched from the port of the CO.

Watermarks—Workload Levels

The load on each agency is constantly measured against low and high watermarks, analogous to high tide and low tide. Whenever the measured load rate is between the low and high watermarks, the node is considered to be an efficiently utilized system resource.

When the load on the agency (load can be measured by a number of ways, for instance, number of tasks or expected number of flops required to execute a task or process) is below the low watermark the node sees itself as being under-utilized. This results in sev ral possible actions, from intensifying the listening on the multicast channel for acquiring additional tasks, to the cancellation of the node in its current role and reassigning it a role which is low on resources in the context of the collaborative system of the present invention as a whole.

When the load on the agency is above the high watermark, the node interprets it as being over worked and may either slow down its acceptance of new tasks and/or request the collaborative system to allocate additional resources to share its load.

The watermarks are dynamic parameters that change constantly for each node, based on the node's current rate of performance and the general parameters of the collaborative system.

In accordance with an alternative embodiment of the present invention, a learning mechanism is inserted into the watermark processing procedure so that the node “learns” to anticipate a situation build-up and act accordingly to maintain optimized operational conditions.

Executions

Tasks contain any or all of the following: a process to perform; task related data; a pointer to a process; or a pointer to task related data. When a thread fetches such an executable task it executes it.

While the resources and available data on the specific executing node satisfy some of the task executions, there are cases in which the execution of a task requires further resources or data, which is unavailable locally, at the executing node. In these cases, components of the task are delegated to other nodes in the collaborative system of the present invention to be executed, and the results of said remote executions are returned to the delegating node.

Chaining

In some cases, a node responding to a request needs the assistance of other nodes. In such cases the concept of chaining is used.

Chaining is actually a process during which control over the execution of a task, or a portion of a task is transferred to another node. Initially, the executing node pauses the process of execution and stores a follow-up task in the task repository, and at the same time it initiates a sequence to ask other nodes of the collaborative system to take over the execution of the task. The requesting node resumes the initial task when the results are received from the assisting nodes.

Bottoming Out

Performing tasks involves many decisions that are taken based on available parameters and data and a specific decision criteria within the context of the participating parties and the nature of the task. More often than not, the available data is incomplete.

Therefore, the system of the present invention foresees that in some cases an ambiguous situation may arise, requiring the decision between equivalent alternatives. Such a case is decided upon by using a coin-flip operation for randomly picking one of the alternatives.

Who Can, I Can, You Do, I Did

The collaborative protocol by which the collaborative system operates is based on the “Who Can-I Can-You Do-I Did” handshake:

When a task generated by one of the nodes requires performance from some of the other nodes in the collaborative system, a multicast message asking the collaborative system's “Who Can” is issued.

The request contains all relevant data required by the responding nodes for the purpose of evaluating whether it is relevant for the execution of the specific request or not.

The “Who Can” request also details the port on which responses are looked for, which is a port on the issuing node's CO.

The “Who Can” inserts to its own task repository, a listening task for fetching the responses to the “Who Can” from the abovementioned designated port.

Nodes listening on their multicast ports pick up the “Who Can” request and evaluate it.

If the result of the evaluation is positive (i.e., the node evaluates itself as relevant enough to respond to the requested task), the responding node sends an “I Can” bid to the issuing node, addressed to the abovementioned designated port, defined in the “Who Can” request.

The “I Can” response details offered performance parameters according to which the issuing node decides which responding node is assigned the task (assuming more than one node responds to the “Who Can” by the time the listening tasks on the issuing node looks at the designated port for answers).

Upon sending the “I Can” message the responding node inserts to itself a listening task to see if it is assigned the task.

The issuing node looks at the response port for the “I Can” responses, evaluates the received responses, and decides which node is assigned with the task.

There are three potential situations:

No response

A single response

Several responses

In a case of no response (either all of the relevant nodes that could have responded are not available and/or there isn't a relevant node) the “Who Can” is repeated. Not receiving a response after a predetermined number of permitted attempts are exhausted, the type of request is changed so that the issuing node insists that an available node (relevant or not) becomes relevant. This feature is the basis for the self-balancing cache storage on the system.

If several responses are given, the requesting node may select any one of the responding nodes to perform the task (based on the parameters sent by the responding nodes and the related decision making process).

Once it selects a responding node to perform the task, the issuing node sends a “You Do” message with the relevant information to the selected responding node (process and data information).

The issuing node inserts to its task repository a new listening task that waits for confirmation that the task was completed.

On all responding nodes, when the listen for job assignment task is picked, the responding nodes look at the designated port for a “You Do” message which relates to them.

Once a responding node is assigned with the task, the other responding nodes which didn't get the task discard the process and free the thread for the next task.

The assigned responding node picks up the task, executes it and upon the task completion, it sends out an “I Did” message to the issuing node, which completes the abovementioned handshake cycle.

The task listening for the “I did” message, posted at the issuing node's task repository, looks for the “I did” confirmation. In case that the wait for said response is timed out, the issuing node asks for an update and/or repeats the entire process from the “Who Can” stage.

Balancing and Optimization

The system of the present invention dynamically assigns processor, cache, and storage roles to its nodes, based on the real time requirements desired from it.

The assignment of roles is based on the abovementioned awareness of the system's nodes to their state and capabilities. As abovementioned, this awareness is achieved by running an introspect on every node as it joins the system.

There are two possible modes of initiating a new node into the system. The first mode is initiation of a node together with the entire system, which is referred to as the ignition of the system. The second mode is initiation of a new node into an already operating system.

In the following paragraphs, only the second mode is discussed. The question of ignition of the entire system is dealt with separately.

New Node Booting

For an already operating collaborative system in accordance with the present invention, the introspect process (which is also an object) is available in the system. It may be found on at least one PSO, (two or more if the PSO is backed up) and any number of duplicate instances may be found on DSO's of the system's nodes.

Each new node is assumed to be capable of booting and automatically load the system initiation executable. The program loaded performs three set-up stages before the new node becomes a part of the collaborative system.

It performs exploration of physical construct and stored objects and creates the relevant inventory objects.

It creates a repository and submits to it a block of listen on multicast tasks.

It creates a basic agency and initiates its operation (threads activation).

Building Workload

The first thing the a joining node does, after its agency is established, is to start listening on the multicast port (i.e., the joining node auto-generates a batch of “listening on multicast ports” tasks)

The newly inserted “listening on multicast ports” tasks pick up requests from the multicast ports and check for relevance. As the new node is not yet loaded with could-be relevant objects, it will respond to requests that do not require any relevance.

After its insertion, the node starts assimilating objects that are required and develop relevance in reference to those requests and related data it has responded to.

Self Balancing

Self-balancing is based on the capability of a node to asses its own situation and ask/offer resources. An example is shown in the following illustration of load sharing negotiation in a PSO overload situation.

Scenario

For the purpose of the illustration the following scenario regarding PSO objects and related put/get tasks for three nodes marked as A, B and C is defined. Please note that the example comprises only three priority levels (i.e., High, Normal and Low). The Low priority parameter is not shown since the receiving node can calculate it as the difference between the total 100% and the sum of the high and the normal priority percentages.

| | |
|---|---|
| Node A | A PSO of 10GB (95% used) with 15% of its tasks marked as |
| | high priority put/get on objects stored by it and 77% as Normal |
| | priority. |
| Node B | A PSO of 16GB (75% used) with 5% of its tasks marked as high |
| | priority put/get on objects stored by it and 90% Normal priority. |
| Node C | A PSO of 6GB (90% used) with 0% of its tasks marked as high |
| | priority put/get on objects stored by it and 70% Normal priority. |

Analysis

Node A, looking at its own situation, interprets the high rate of high priority tasks as an overload, hindering its ability to satisfy the demand flow. This example uses a 10% threshold as the limit of well-balanced priorities (i.e., if more than 10% of the tasks are high priority tasks, the node interprets the situation as an overload).

Node A deduces it is holding, on its PSO, a non-balanced popularity distribution of objects—too many of them are being modified/read too frequently.

Node A requires a corrective action. It needs to re-distribute its objects with other PSO objects and balance itself so that the priority of its tasks is reduced.

Node A requests assistance from other PSO components in the collaborative system.

Who Can

Node A uses the “Who can” multicast requesting other PSO in the collaborative system to respond to its need for redistributing of its stored objects

<HOM>

<MSG TYPE> = Who Can (PSO objects swap)
<Identity Origin>

<Origin ID> = NODE A
<MSG ID> = 12354
<Answer port> = 34562

<Parameters>

<Total Size> = 10E9
<Used> = 95
<Criticality>

<High> = 15
<Normal> = 77

<EOM>

I Can

The listening task inserted into the task repository for request 12354 retrieves the following two responses from port 34562 on Node A.

<HOM>

<MSG TYPE> = I Can (PSO objects swap)
<MSG Priority> = Normal
<Identity Origin>

<Origin ID> = NODE B
<MSG ID> = 97648
<Answer port> = 22453

<Identity Target>

<Target ID> = NODE A
<MSG ID> = 12354
<Answer port> = 34562

<Parameters>

<Total Size> = 16E9
<Used> = 75
<Criticality>

<High> = 5
<Normal> = 90

<EOM>
And
<HOM>

<MSG TYPE> = I Can (PSO objects swap)
<MSG Priority> = Normal
<Identity Origin>

<Origin ID> = NODE C
<MSG ID> = 87435
<Answer port> = 33765

<Identity Target>

<Target ID> = NODE A
<MSG ID> = 12354
<Answer port> = 34562

<Parameters>

<Total Size> = 6E9
<Used> = 90
<Criticality>

<High> = 0
<Normal> = 70

<EOM>

You Do

For the purpose of this example a very simplistic approach is used as a decision mechanism—assuming that the task criticality is evenly distributed between all the objects in the PSO.

In accordance with the exemplary embodiment of the present invention, a much more sophisticated algorithm is used, based on analyzing the actual load associated with each object on A and prioritizing the most needed objects for transfer. By using such an algorithm, the total volume required to be transferred to re-balance node A will be lower.

In this example we also assume that a swap can only be executed between two PSO, and therefore an allocation of some of the objects from A to B and some to C is not permitted.

From the responses obtained by the listening task, node A constructs a table assisting it in evaluating what course of action to adopt.

| | | Node A | Node B | Node C |
|---|---|---|---|---|
| Size | Total (GB) | 10 | 16 | 6 |
| | Free | 5% | 25% | 10% |
| Tasks load | High | 15% | 5% | 3% |
| | Normal | 77% | 90% | 70% |
| | Low | 8% | 5% | 27% |
| Volumes (GB) | High | 1.43 | 0.60 | 0.16 |
| | Normal | 7.32 | 10.80 | 3.78 |
| | Low | 0.76 | 0.60 | 1.46 |
| | Free | 0.50 | 4.00 | 0.60 |

The first mode of dealing with the abovementioned situation is called “Push-out”, in which Node A pushes enough objects to another node and therefore solves the problem.

| Type | | Total | Free | High | Normal | Low |
|---|---|---|---|---|---|---|
| A | Pre transfer | 10.00 | 0.50 | 1.43 | 7.32 | 0.76 |
| | Need to | 3.17 | | 0.48 | 2.44 | 0.25 |
| | Post transfer | 10.00 | 3.67 | 0.95 | 4.88 | 0.51 |
| | % Post | | 37% | 10% | 49% | 5% |
| B | Pre transfer | 16 | 4.00 | 0.60 | 10.80 | 0.60 |
| | Post transfer | 16 | 0.83 | 1.08 | 13.24 | 0.85 |
| | % Post | | 5% | 7% | 83% | 5% |
| C | Pre transfer | 6 | 0.60 | 0.16 | 3.78 | 1.46 |
| | Post transfer | 6 | (2.57) | 0.64 | 6.22 | 1.71 |
| | % Post | | −43% | 11% | 104% | 29% |

A transfer to Node B will solve the problem for node A and will not create a problem for node B; a simple transfer is not feasible with node C.

Node A issues a “You Do” message to node B for handling the swap.

<HOM>

<MSG TYPE> = You Do (PSO objects swap — You take)
<MSG Priority> = Normal
<Identity Origin>

<Origin ID> = NODE A
<MSG ID> = 76354
<Answer port> = 42317

<Identity Target>
<Target ID> = NODE B
<MSG ID> = 97648
<Answer port> = 22453
<Parameters>

<Total Size> = 3.17E9
<ID list> = {.........}
<Objects Sizes> = {.........}
<Port ID> = {...}

<EOM>

Swapping

Node B, upon fetching the “You Do” message by its listening task on port 42317, establishes a peer-to-peer connection with node A and retrieves the specified objects.

After all the objects have been locally stored on the PSO of node B, it is ready to confirm performance by an “I Did” message.

I Did

Node B issues the following “I Did” message:

<HOM>

<MSG TYPE> = I Did (PSO objects swap — I took)
<MSG Priority> = Normal
<Identity Origin>

<Origin ID> = NODE B
<MSG ID> = 98745

<Identity Target>

<Target ID> = NODE A
<MSG ID> = 76354
<Answer port< = 42317

<Parameters>

<Total Size> = 3.17E9
<ID list> = {.........}

<EOM>

Node A upon retrieving the “I Did” from port 42317 deletes the objects from its PSO (based on the list included in the message).

Roles

As mentioned above a node can assume a variety of roles (one or more per node) depending on its physical substance (and capabilities). In the following paragraphs, the basic roles that enable the operation of the collaborative system of the present invention are outlined.

Basic Agency

A basic agency role can run on any node comprising a CO, a PO and a DSO. The role of the basic agency is to perform processes.

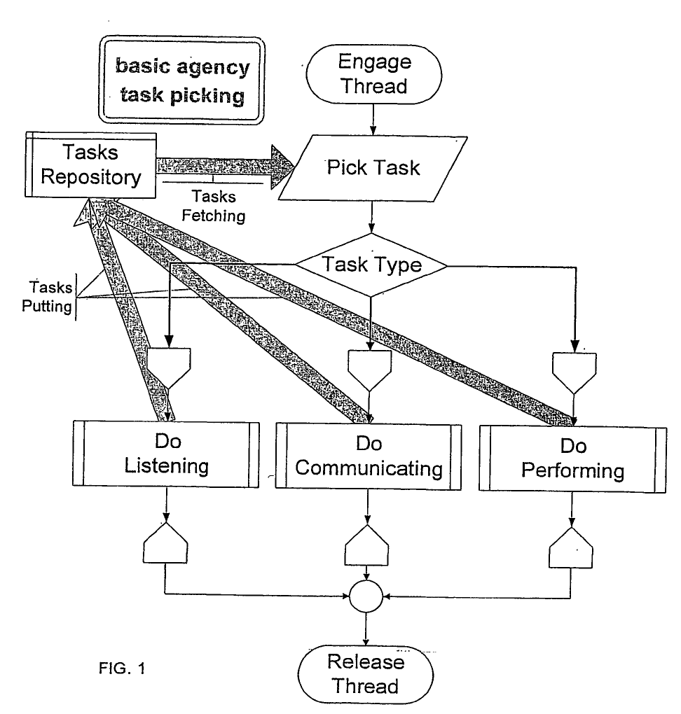

With reference to FIG. 1, there are three types of tasks that may be picked from the tasks repository by a basic agency:

Listening—a task type designated for listening on one of the communication ports of the node.

Communicating—a task type designated for participating in a communication step as part of the dialog between nodes.

Performing—a task type designated for performing any type of identified process.

Listening

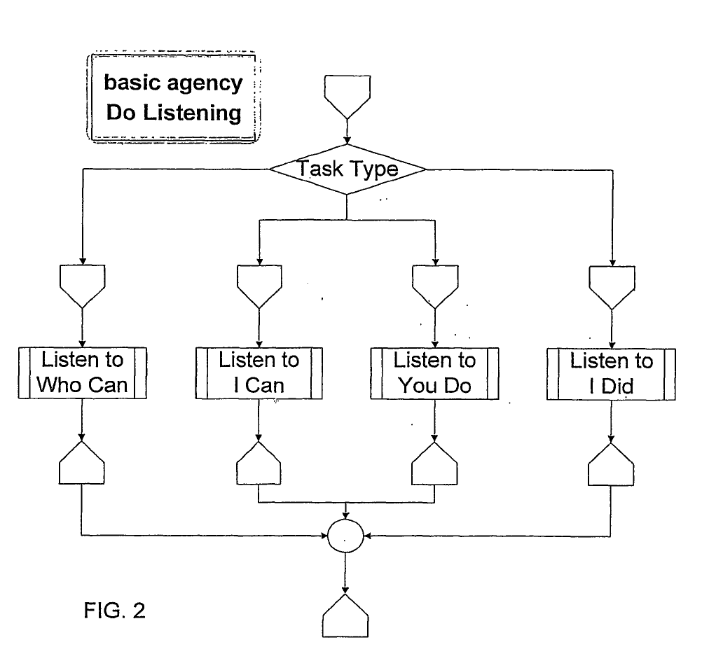

With reference to FIG. 2, there are four sub-types of listening tasks, namely “Who Can”, “I Can”, “You Do” and “I Did”, each responsible for awaiting a specific type of transmission from another node in the collaborative system.

Listen For Who Can

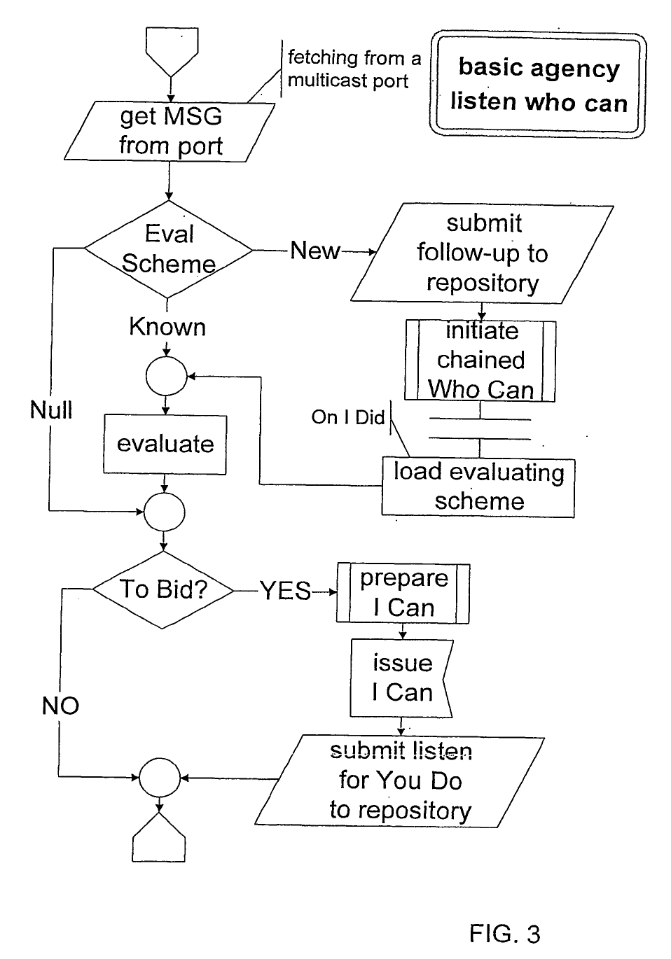

Referring to FIG. 3, all the nodes of the collaborative system share a common set of ports (port identifiers are the same for all nodes) designated to listening for “Who Can” multicasts. These ports are referred to as multicast ports.

The “Who Can” message comprises of the following components:

Request identification

Issuing node ID

Request ID

Port to answer to

Request class

Type of request

In addition to the above, the “Who Can” message may also specify the following:

Object ID and parameters of the relevance evaluation scheme

Priority flag (default is normal)

Activities forecast (enabling the node to guarantee performance)

Relevance evaluation schemes may be of several archetypes:

Null—No relevance is required

Data only—A request for a set of passive objects to be present

Process only—A request for a set of active objects to be present

Combined—A request for evaluating a combined passive and active objects' availability.

While evaluation of Null does not require any evaluation, and Data only and Process only are simple lookup into the inventory objects, the combined evaluation scheme may require execution of an active object (the evaluation scheme) that is not available on the node.

In such a case the response of the evaluating node is paused and it sends out a “Who Can” message for obtaining the required evaluation scheme.

Priority flagging takes effect when processing a “Who Can” results in chaining—the original process is halted and stored inside a continuation task (in the task repository) and a “Who Can” sequence for fetching required components or results is initiated.

When chaining is activated the follow-up task and all chained activities are marked with the priority flagging of the “Who Can”. This flag influences the order by which tasks are picked up from the repository.

Listen for I Can

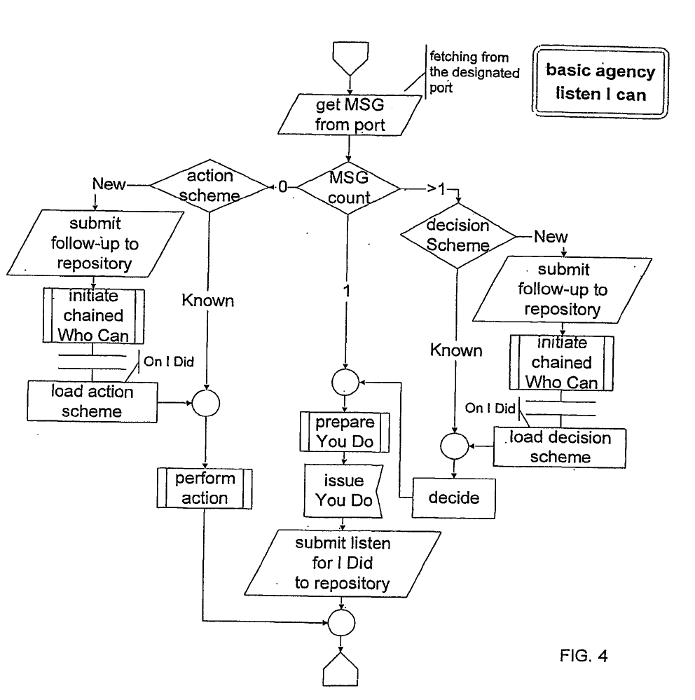

With reference to FIG. 4, when a “Who Can” message is issued, a “listen for I Can” task is inserted into the issuing nodes' task repository. Said “listen for I Can” task fetches the responses to said “Who Can” message.

The “I Can” message comprises of the following:

“Who Can” message requests identification from the “I Can” message (so as to cross check that the “I can” message is responding to the correct “Who Can” message. In accordance with an alternative embodiment of the present invention, said identification request and is also used as an encryption/certification mechanism)

“I Can” message response identification (enabling the “You Do” message to be sent to the appropriate node)

In addition to the above, the “I Can” message may also include the following:

Score obtained by the evaluation scheme used (default is minimal requirement obtained)

Performance guarantee (the time it will take the responding node from obtaining the “You Do” message to get to the sending of the “I Did” message following the performing of the task)

In accordance with an alternative embodiment of the present invention the “I Can” concept is extended into an “I Can and Here It Is” concept, enabling nodes to send the result of the performing of the task with the “I Can” message. If this method is used the negotiation process stops as the issuing node gets its reply (by selecting an “I Can and here it is” response).

There are three possible cases when the “listen for I Can” task fetches responses from the port:

No Response

A single response

Multiple responses

Not having any response causes for several alternative different courses of action that are specified in the original task itself. The actions are resubmission of the listening task and increasing an index for the number of resubmissions, discarding the task and issuing a new “Who Can” message with or without changing the message's parameters, for example, the requested relevance may be diminished and increasing the priority of the request. Choosing between these alternatives is made according to a decision scheme.

Having a single response is the simplest case since the responding node will immediately be issued the “You Do” message.

Having multiple responses require the issuing node to perform a decision according to a decision scheme that is specified in the original task. The decision scheme evaluates three parameters:

The relative quickness of the responses (topological proximity of the responding node to the issuing node)

The relevance of the responding node to the request

The performance bid of the responding node

In need of using a decision scheme (for selecting a course of action in case of no response or for selecting the winner from multiple responses) chaining is needed. The process of evaluating the responses is suspended, a follow-up task inserted into the task repository and a “Who Can” message is issued to retrieve the missing components.

Listen on You Do

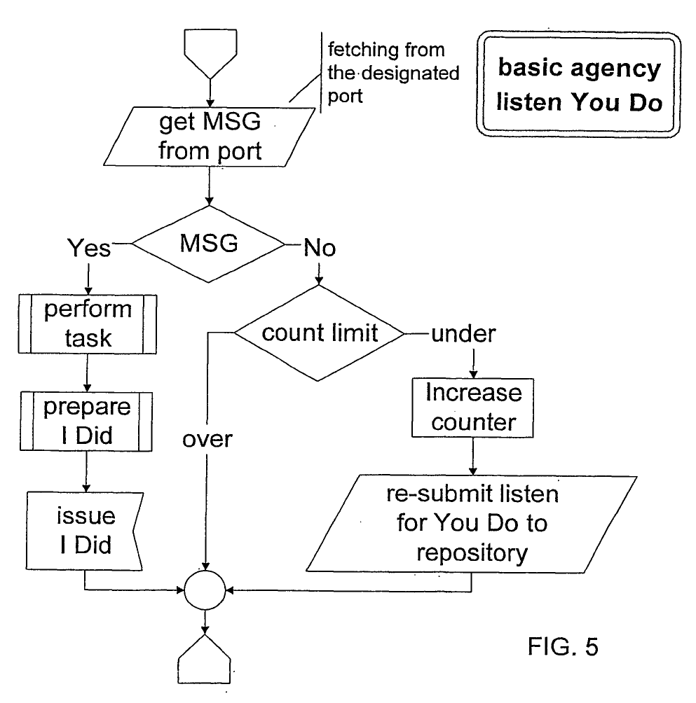

Referring to FIG. 5, once a responding node was selected, a “You Do” message is issued to it. The nodes that have responded to the initial “Who Can” message are listening for the “You Do” message on the port designated therefor.

There are two possible situations:

There is a message on the port.

There isn't a message on the port.

From a responding node's point of view, when there is no message it may be that the task was assigned to another responding node, or that the “You Do” message has not arrived yet.

Depending on the task's type, the “listen for You Do” task is resubmitted for a pre defined number of times before the node concludes that the task was assigned to another responding node, and discards the listening task.

Once a “You Do” message is fetched from the designated port, the responding node, which received the “You Do” message has to perform the task.

The “You Do” message will include all the data needed for the node in order to perform the task and the port for the “I Did” message upon completion.

In some cases the “You Do” message includes a designated port on the issuing node to perform a collaborative mode processing (such as the PSO swap example).

The “You Do” message may also define if the task is a “fire and wait” task or if the issuing node requires updates in mid-process. If an update is required, the “You Do” message specifies the milestones in which an update is wanted so that the responding node selected to execute the task may issue the updates (to the “I Did” designated port).

Listen for I Did

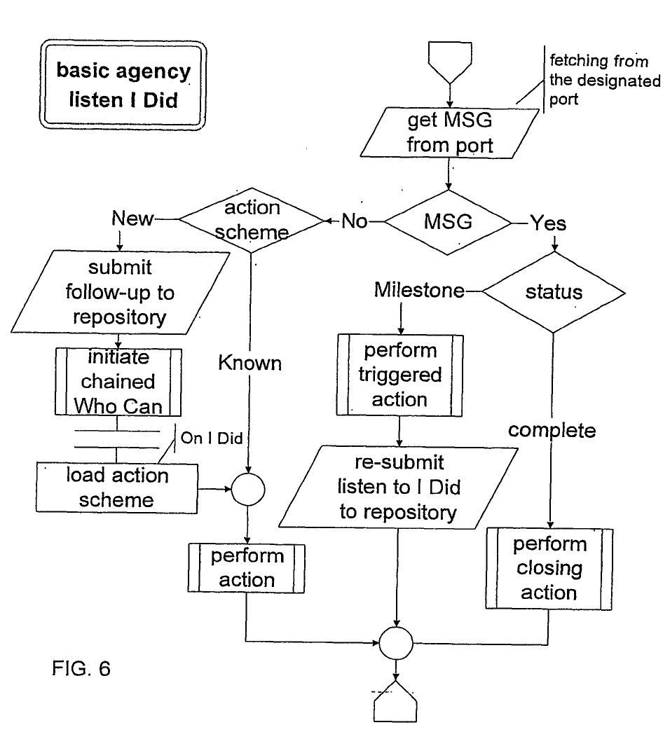

Referring to FIG. 6, the “Listen For I Did” task looks at the designated port to receive updates on the progress of the task, or, if the task is a “fire and wait” task the “Listen for I Did” task only looks for the “I Did” messages.

Depending on the task, action schemes are defined for cases in which the expected response is not given by the time it is looked for.

Some of the activities performed by a node are intermediately reported (i.e., progress reports/milestones). Said intermediate reports cause for triggering of one of the system's messages (e.g., “Who Can”, “I Can” or “You Do”).

Communicating

There are three types of communication activities a basic agency performs:

Send multicast message (when issuing a “Who Can” message)

Send to designated port (when issuing an “I Can” message, a “You Do” message or an “I Did” message)

Establish special (when a handshake is established between nodes).

Depending on the communication protocol the collaborative system of the present invention is using, rappers are used for translating the XML-like objects into transmittable packets.

Performing

The agency performs a task by loading the required active object and allocating the thread to perform it.

Depending on the task, the agency performs any computable process of manipulating data, sending messages and making decisions.

Watermarks

The basic agency's watermark is established to monitor the load on it and to enable it to estimate its performance time when responding to a Who Can.

There are three issues we need to address regarding the watermark:

Load data updating

Over boundary actions

Estimating performance time

Load updating

Some of the activities performed by the agency report a load update. A special object in each agency maintains the current (most updated) load parameters.

Since not all the activities report their load, extrapolation is used to estimate the entire agency's load data.

The load object also maintains a history so that trends are detected and preventive action is taken.

Over Boundary Actions

There are two types of over boundary conditions:

Overload—the load (or the estimated load within a given time period based on trend analysis) is over the upper threshold defined for the agency.

Under work—the load (or the estimated load within a given time period based on trend analysis) is under the lower threshold defined for the agency.

Reacting to Overload

There are several actions that may be taken when an agency detects it is in an overload or approaching an overload condition.

The reaction scheme is based on increasing the potency of the action step by step, while the starting point of the process is based on the situation when it is invoked.

The first step is to decrease/eliminate the listen for multicast tasks in the agency's task repository.

Since in some cases a load rush may be the result of performing a task that generates additional activities, not listening on multicast may give some relieve, but it will not solve the problem.

Therefore, in such cases the agency has to transfer some of its load to other agencies. Performing load transfer necessitates an analysis of the task repository as only non-chained processes may be moved. Moving a task that has already created sub-tasks that are being performed on other agencies is difficult, as the other agencies will respond to the original node that will not be valid anymore by the time responses will be sent.

Failing to stabilize the load by using the elimination of “listen to multicast” tasks, the agency, picking tasks that are fully contained within the agency (if any) issues a “Who Can” assume my tasks message specifying the associated load.

The decision making scheme may either select a single agency, transferring to it the entire block of tasks, or it may pick a list of agencies, and allocate some tasks to each, based on their bid (their ability to absorb additional load).

Not receiving an “I Can” message in response for the “Who Can” assume my tasks message, indicates that the entire collaborative system of the present invention is overloaded. In such a case, the agency may issue a different “Who Can” message asking nodes to become basic agencies (assuming there is capacity that can be reassigned from other types of agencies).

Reacting to Under-Work

The first reaction an agency takes for increasing its load is to add a block of listen to multicast tasks.

In a steady state operation, however, as the balance of already relevant agencies is established, the probability of an agency to increase its load by intensely listening to multicasts is low.

In such a case the agency issues a “Who Can” message asking other agencies to assign load to it.

Ultimately an agency issues a “Who Can” message asking other agencies to indicate a need of agency type change. The agency will include in its “Who Can” message its physical construct so the responding agencies may evaluate the roles it may assume.

Estimating Performance Time

When an agency responds to a “Who Can” message it includes its estimation for the time it will take it to perform the task.

The estimation is based on the capabilities of the physical construct of the responding node on which the agency is running but also on the load situation of the agency, this being since an agency with a high load parameter will take longer to get its attention to the specific task.

In calculating the estimated time of performance, the agency looks at its construct object and at its load object to complete the calculation.

Persistent Storage Agency

A Persistent Storage Agency may be invoked on any node having a PSO component. While the persistent storage agency is similar to the basic agency it is equipped with several unique capabilities, enabling it to perform the role of managing the persistent storage components.

Object Creation

Persistent storage agencies are responsible for the creation of new objects (as well as for their modification and deletion which are dealt with later on in this paragraph).

When the collaborative system of the present invention requires the creation of a new object, the agency initiating it issues a “Who Can” message for the creation of the object.

Only persistent storage agencies are qualified for this task. Said persistent storage agencies decide if they are relevant for the execution of said process according to the information supplied by the abovementioned request (i.e. object class and estimated volume), and if relevant, they respond with an “I Can” message.

Once an agency is assigned the task to creating an object, it writes the new object on its PSO, updates its inventory, and initiates the creation of backups.

Inventory

The “I know what I know” principle when extended to the persistent storage manager is realized as an object maintaining the inventory of the local objects on the persistent storage device.

The inventory, on top of listing the objects available on the device, also contain other relevant data such as last time of update, last time of fetch, specific flags indicating if it's the master or a backup instance, call for backup policy etc.

A copy of the inventory is also stored on the persistent storage device so that when a node is re-booted, the inventory can be retrieved.

Backing Up

There are three separate issues related to backing up objects:

Backing up newly created objects

Updating a backup version of an existing object

Restoring from a backup copy

Backing Up New Objects

When a new object is created on a persistent storage agency, depending on the policy associated with its class, several backup objects may be required.

The agency, following writing the object to its own PSO, issues a “Who Can” message asking other persistent storage agencies to create backups.

All other persistent storage agencies that have been assigned the creation of the backup mark the objects they create as backups (in the inventory object they maintain).

The issuing agency (the one containing the master) marks in its inventory that it has the master object.

Updating Backup Objects

Whenever a master object is updated, the agency performing the update decides if backup objects should also be updated.

The decision is based on the policy associated with the object's class and may vary from immediate update to all available backups up through a staggered scheme maintaining several copies of various ages.

When a backup update is required, the agency controlling the object (master copy) issues a “Who Can” message asking the backup holders to update their copy.

Restoring From Backup

In cases where the PSO maintaining the master object is not functioning, an agency on the collaborative system of the present invention, designated for that purpose, detects that a master object is lost. In such a case, said agency, after verifying that the master object is indeed lost, issues a “Who Can” message for all persistent storage agencies to detect a backup copy.

Once a backup copy is detected, the inventory of the persistent storage agency is updated so that said backup copy is labeled as a master copy, and a new back up object is generated on one of the other persistent storage agencies.

Cyclical Modifications Batching

Whenever a modification to an object is required, the initiator of the modification uses a “Who Can” message to attract the attention of the persistent storage device that maintains the master instance of the to-be-modified object.

Each of the agencies evaluate their relevance to the “Who Can” message by looking for the to-be-modified object in their respective inventory object. The agency that holds the to-be-modified object sends an “I Can” message to the requesting agency, which issued the “Who Can” message.

Upon receiving the “I Can” message, the requesting agency issues a “You Do” message to the receiving agency, after which stage the receiving agency takes the modification request and appends it to a specialized repository containing all requests for change in locally available objects (i.e., objects that are stored on the local PSO).

This repository, organized (sorted) by object identifiers, holds all pending changes to a specific object together.

When the conditions calls for it (as detailed below) a thread takes all the changes for a specific object and performs them so that the object on the persistent storage object is updated.

Only after the changes have been actually written to the persistent storage object, relevant “I Did” messages are sent to let the agencies requesting the changes know that the task has been performed.

For each object class, an evaluation scheme (for making the write to object decision) is defined enabling the agency to affect the changes optimally.

Balancing

Some objects are more popular than others. This popularity has two different aspects:

The frequency of an object's fetching.

The frequency of an object's updating.

The load on a persistent storage agency is directly associated with the popularity distribution of the objects it maintains.

When an agency is overloaded (too many popular objects) it slows down the entire collaborative system of the present invention, as the overloaded agency tends to be unavailable for modification and fetch requests, necessitating in many repetitions over the same requests.

When such an overloaded agency responds to a “Who Can” message it is also given the information on the number of repetitions the “Who Can” message was repeated before it actually reached the overloaded agency.

High criticality of requests indicates an overload situation of the agency, and triggers a corrective response. An example of such a situation is described in the PSO swap example.

Dynamic Storage Agency

A dynamic storage agency is a basic agency in all respects implemented on a node having a relatively large DSO.

The advantage of the dynamic storage agency, having a large DSO is that it can be relevant for many “Who Can” requests, which requires the related objects to be stored locally. The reason for this probable relevance is that when an agency is assigned to perform a task it has to fetch all the related objects to its local DSO. Having a large DSO implies that the agency maintains previously used objects, and if so, it is more relevant to perform specific tasks (the above is said in comparison to other agencies with smaller DSOs, which are more probable not to have the relevant objects).

When an agency is given the “You Do” message for a task it was not 100% relevant for (i.e., it did not have all the required objects locally), it issues a series of “Who Can” requests to supply it with the missing objects. Responses may come from the PSO maintaining the master or from any other DSO having a local backup of the object.

Inventory

The dynamic storage agency maintains an inventory of the objects it stores. Each record of an object in the inventory contains the object ID, the pointer to the object's storage location, and various attributes such as the object's age etc.

Time Stamps

When an object is fetched from a PSO it is given a time stamp defining its age. This time stamp is part of the dynamic copy of the object thus created and follows it when it migrates or cloned between dynamic agencies.

When an agency evaluates its relevance it may disqualify objects from being regarded as available locally, if they are too old (determined by the relevant evaluation scheme).

Further, a dynamic instance of an object is declared dead according to its age, the class of the object and its update frequency.

Freshening Up

In accordance with an alternative embodiment of the present invention, whenever a dynamic agency fetches an object (from another dynamic agency or from a persistent storage agency) it includes in the “Who Can” message, the entire list of the objects it maintains.

The responding agency, other than responding to the specific “Who Can”, offers fresher versions of objects they both have, even if they are not related to the specific “Who Can” request being processed.

Gateways

A gateway is a special node capable of communicating with networks or computers external to the environment of the collaborative system of the present invention.

The gateway is responsible for communicating between the collaborative system of the present invention and external environments by accepting requests on its external leg and communicating them into the collaborative system through its internal leg, and transmit responses retrieved by its internal leg to external environments through its external leg.

Compiling Requests

A gateway can be looked upon as a sort of compiler enabling the interpretation of outside requests into “Who Can” requests readable by the protocol of the collaborative system of the present invention, that initiates the process for obtaining the required response.

But, unlike a compiler, which is unidirectional, the gateway interprets both ways; unfolding accepted requests coming from outside of the collaborative system, and wrapping responses in formats acceptable by the requesting entity.

Security

The gateway is also responsible for the security and integrity of the collaborative system, not letting in any object that is not authenticated and verified.

Multi Collaborative System

In an alternate embodiment of the present invention, the gateway is also used to create multiples of collaborative systems—connecting two or more collaborative system environments together. By putting each leg in a different collaborative system, and because all collaborative system environments are using essentially the same protocol, tasks originating on one collaborative system can be directed (or allowed to migrate) into another collaborative system by merely opening a gateway.

Input and Output

With reference to FIG. 7, nodes equipped with PIDO and/or PODO components are able to run a specialized agency operating the peripheral device. In many respects, the Input/Output agency is like a gateway either accepting requests from a given device (i.e. keyboard, mouse etc.) or issuing responses to a given device (i.e. monitor, siren etc.).

Like the gateway, the input/output agency is equipped with compiling and wrapping APIs enabling it to communicate with the relevant devices

Administration

In accordance with an alternative embodiment of the present invention, the collaborative system is equipped with an administration agency, enabling the administrator(s) to intervene and create changes in the collaborative system.

An example for such an action may be the introduction of a new object into the system, a version change on an active object, a template change in an object's class etc.

Ignition

There are two aspects to ignition:

Starting up a new node upon joining an established collaborative system of the present invention.

Starting up of a collaborative system instance.

New Node Booting

When a node boots, following its own operating system loading up process, it runs a sequence of operations responsible for joining a collaborative system. As mentioned above, an autoloader will call the execution for a collaborative system joining procedure.

This procedure is composed of three steps:

Running Introspection.

Establishing a basic agency

Creating a load of listen to multicast tasks.

Introspection

The introspection procedure (an active object) is dependant on the operating system under which the booting node is supposed to run. The operating system, when executing its booting sequence, calls for the appropriate introspection procedure and automatically executes it as the last stage of its booting sequence.

It is assumed that the procedure is available locally on the booting node, or that the booting node has the capability to retrieve it over a network connection.

The Introspection is responsible for achieving the node's awareness for its physical construct (“I know what I am”) and for objects it maintains (“I know what I know”).

When igniting a node with a PSO, an inventory of objects maintained on the PSO can be retrieved from it and established on its DSO. If the booting node has no PSO, or in cases where the PSO is empty, a just-booted. node will not have any knowledge except for the introspection object itself.

The introspection procedure will create three objects in the DSO of the booting node:

The physical construct object.

The inventory object.

The load object.

As mentioned above the inventory is fetched from the PSO or created as an empty template for nodes without a PSO (or PSO data).

Basic Agency Initiation

Once the introspection has executed and the physical construct and inventory objects established, the booting up sequence initiates a basic agency on the node.

The creation of the basic agency involves the establishment of a repository, related objects needed by the agency for its operation (i.e., watermark system) and assignment of communication ports for different roles (i.e., designation of multicast listening ports).

Loading up

Once the agency is operating a block of listen for multicast tasks is inserted into the task repository so that the agency may start to assume load.

Starting Up a Collaborative System of the Present Invention

For starting up a collaborative system, a node (any single node) equipped with either a removable media (i.e. CD, Floppy etc.) or network connection (e.g. LAN, WAN, WWW) is booted. Introspect is run from its removable media device or network neighborhood.

Once the agency is running on that node, and it has knowledge of all the components that are required by other nodes for their booting up, neighboring machines are booted in a similar way, and all are joined together to form a collaborative system.

It should of course be understood that the foregoing description of an exemplary embodiment of the present invention is merely an example. It is anticipated and expected that one of skill in the art may make many alterations and modifications of the exemplary embodiment and still be within the spirit and scope of the invention which is solely determined by reference to the claims appended hereto.

What is claimed is:

1. A system for non-hierarchical collaborative computing, comprising at least two basic nodes, wherein each of said at least two basic nodes has at least one agency, each of said at least one agencies having incorporated therein a collaborative protocol, wherein said collaborative protocol enables a non-hierarchical collaborative computer processing to occur within said system.

2. A system for non-hierarchical collaborative computing in accordance with claim 1, wherein each of said nodes comprises:
a) a processor unit;
b) a random access memory unit; and
c) a communication device.

3. A system for non-hierarchical collaborative computing in accordance with claim 1, wherein any hardware functionality is represented by a functioning corresponding object.

4. A system for non-hierarchical collaborative computing in accordance with claim 1, wherein each of said at least one agencies comprises:
a) a dynamic storage object;
b) a processing object; and
c) a communication object.

5. A system for non-hierarchical collaborative computing in accordance with claim 3, wherein at least one of said agencies further comprises a peripheral input device object.

6. A system for non-hierarchical collaborative computing in accordance with claim 3, wherein at least one of said agencies further comprises a peripheral output device object.

7. A system for non-hierarchical collaborative computing in accordance with claim 3, wherein at least one of said agencies further comprises a persistent storage object.

8. In a distributed computation cluster, a method for processing of tasks by auctioning, said cluster comprising an auctioning node and a plurality of receiving nodes, wherein said auction comprises the steps of:
a) generation and transmission of an offer from said auctioning node to said receiving nodes;
b) evaluation of said offer by each of said plurality of receiving nodes to arrive at a determination of said receiving nodes' offer-fulfillment capability;
c) generation and transmission of bids by bidding nodes to said auctioning node, said bidding nodes comprising those of said receiving nodes that make a positive determination of offer-fulfillment capability;
d) evaluation of said bids by said auctioning node to select a preferred bidding node;
e) acceptance of a preferred bid by said auctioning node sending said auctioned task to said bidding node which originated said preferred bid;
f) processing of said task by said bidding node; and
g) transmission of the results of said processing back to said auctioning node.

9. A cluster of computing units wherein said computing units are communicatively interconnected with one another, each of said computing units comprising:
a) a non-hierarchical collaborative protocol;
b) at least one processing object;
c) at least one dynamic storage object; and
d) a communication object.

10. A community of computing units in accordance with claim 9, wherein said non-hierarchical collaborative protocol comprises a data-flow paradigm.

11. A protocol for non-hierarchical collaboration between computing units.
